(19) United States
(12) Patent Application Publication
(10) Pub. No.: US 2026/0355747 A1
(43) Pub. Date: Nov. 12, 2026

(54) SAMPLE CONTAINER SYSTEM

(71) Applicant: MLS Mikrowellen-Labor-Systeme GmbH, Leutkirch (DE)

(72) Inventor: Werner Lautenschläger, Heerbrugg (CH)

(21) Appl. No.: 19/103,030

(22) PCT Filed: Aug. 4, 2023
(86) PCT No.: PCT/EP2023/071673

§ 371 Date: Feb. 11, 2025

(30) Foreign Application Priority Data
Aug. 11, 2022 (DE) 20 2022 104 567.4

(51) Int. Cl. B01L 3/00

(52) U.S. Cl. CPC B01L 3/50825; B01L 2200/026; B01L 2300/042; B01L 2300/046; B01L 2300/12; B01L 2300/14

(57) ABSTRACT

The present invention relates to a sample container system (1) for use in a pressurised container (100), having a sample container (2) with a sample container chamber (3) for receiving a sample (P) and with an edge (21) which defines an opening (22); and having a cover (4) for closing the opening (22). The cover (4) has: an insertion portion (41) which can be inserted into the sample container (2) via the opening (22) and by means of which the cover (4) can be moved axially relative to the sample container (2), a flange (43) which extends radially outwards starting from the insertion portion (41) and, when the insertion portion (41) is inserted in the sample container (2), can rest, with a contact side (44), on the edge (21), and a recess (46) which extends axially in an outer face (42) of the insertion portion (41) and then extends radially outwardly in the contact side (44) of the flange such that, when the insertion portion (41) is inserted in the sample container (2) and the contact side of the flange (43) rests on the edge (21), the sample container chamber (3) is fluidically connected via the recess (46) to the surroundings (U) of the sample container system (1). The invention also relates to a pressurised container (100) having a sample container system (1) according to the invention.

The invention relates to a sample vessel system for use in a pressure vessel and to a pressure vessel having such a sample vessel system.

Pressure reactions on samples are conducted in order, for example, to analyze a sample. For this purpose, the sample is accommodated in a sample vessel, which is then subjected to a chemical and/or physical pressure reaction in a pressure vessel. With the sample vessel, it is possible in particular to easily provide the sample in the sample vessel and also to easily remove it again therefrom.

The pressure reaction in the sample can have the effect that a pressure in the sample vessel rises, for example owing to an exothermic reaction that proceeds in the sample vessel. The pressure may rise here in a disadvantageous manner. For example, the pressure vessel may be damaged by an undesirably rapid rise in pressure or some other unwanted effect (damage to the sample, distortion of analysis results etc.) may occur.

It is thus an object of the present invention to overcome the abovementioned disadvantages, i.e. in particular to better regulate the pressure in a sample vessel.

This object is achieved by the subject matter of the independent claims. Advantageous developments are the subject of the subsidiary claims based thereon.

In a first aspect, the invention relates to a sample vessel system for use in a pressure vessel. The sample vessel system comprises: a sample vessel having a sample vessel space to accommodate a sample and an edge that defines an opening; and a lid to close the opening. The lid has: an insert section which is insertable into the sample vessel via the opening and via which the lid is movable axially relative to the sample vessel; a flange which extends radially outward proceeding from the insert section and, when the insert section is inserted into the sample vessel, can lie on the edge by a contact side, and a cutout that runs axially within an outer surface of the insert section and then radially outward in the contact side of the flange, such that, when the insert section is inserted into the sample vessel and the flange lies on the edge by the contact side, the sample vessel space is fluidically connected to the environment of the sample vessel system via the cutout.

With the sample vessel system, it is possible to regulate a pressure that exists within the sample vessel space in a particularly simple manner. Firstly, in the state in which the lid is inserted into the sample vessel via the insert section thereof, a gas (for example a gas required for a reaction in the sample vessel space, for example to build a pressure envisaged in the sample vessel space, preferably in the range from 10 to 60 bar) may be supplied to the sample vessel space via the fluidic connection provided by the cutout between the environment (for example a gas that surrounds the sample vessel system in a reaction chamber of a pressure vessel, or ambient air) and the sample vessel space, or a gas (for example a gas formed in a reaction in the sample vessel space) may be removed from the sample vessel. Secondly, a positive pressure in the sample vessel space can result in axial movement of the insert section inserted into the sample vessel through the opening, which results in pressure equalization with the environment. While the insert section is moving axially through the opening, the cutout is simultaneously moved through the opening, which causes the cutout to be at least partly exposed, hence increasing the size of an opening via which a gas can flow out of the cutout. If the lid is thus raised owing to a positive pressure rising within the sample vessel space, a greater gas flow can flow out of the sample vessel space via the enlarged opening and hence a disadvantageous pressure profile and/or an undesirably high pressure in the sample vessel space can thus be prevented.

There is thus in particular no risk that parts of the sample vessel system (especially sample vessel and/or lid) will be damaged owing to a pressure gradient between environment and sample vessel space. Moreover, pressure regulation in the sample vessel space is easily possible by virtue of the configuration of the lid, especially without having to adjust parameters of a pressure vessel (for example pressure regulation in a reaction chamber and/or supply of a reaction gas) in which the pressure vessel system is employed. The lid thus constitutes what is called a self-regulating lid or, in other words, a vessel closure with a valve effect.

When the insert section is inserted into the sample vessel, it is preferable when the lid is movable axially at least between a first position and a second position by lifting relative to the sample vessel, wherein at least a portion of the cutout is covered by the sample vessel in the first position and projects beyond the edge in the second position and hence is exposed. The lid may be movable from the first position into the second position, for example, via a rise in pressure in the sample vessel space. In the first position, a gas preferably flows via the cutout into the sample vessel space, in order in particular to bring about equalization of pressure between environment and sample vessel space and hence to prevent pressure deformation of the vessel. In the second position, by virtue of the exposed portion of the cutout, it is possible in particular for a greater gas flow compared to the first position to leave the sample vessel space via the cutout, which can likewise bring about compensation of pressure between environment and sample vessel space, especially when a pressure is rising (for example owing to a chemical reaction) in the latter. Pressure regulation in the sample vessel space is thus provided in a particularly simple manner.

The sample vessel preferably extends axially along a longitudinal axis; when the insert section is inserted into the sample vessel, the portion of the cutout that runs within the outer surface of the insert section runs at least partly parallel to the longitudinal axis. In this way, the cutout may be moved particularly advantageously relative to the edge of the sample vessel, for example essentially perpendicularly. This is advantageous in particular for pressure regulation in the sample vessel space. Moreover, the cutout can thus be provided in a particularly simple manner in the outer surface of the insert section. The portion of the cutout that runs within the contact side of the flange preferably extends perpendicularly to the longitudinal axis of the sample vessel.

The cutout is preferably slot-shaped. This means that the cutout preferably has an elongated shape. The cutout preferably consists solely of one or more straight sections. For example, the cutout may consist solely of two straight sections, where the first section is provided in the contact side of the flange and the second section in the outer surface of the insert section.

The insert section preferably has an underside (i.e. a side facing away from a top side of the lid), which bounds the sample vessel space when the insert section is inserted into the sample vessel, where the cutout extends away from the underside and/or extends proceeding from the underside.

The insert section may be at least partly cylindrical and/or conical. The insert section may have a round (preferably circular) cross section. Viewed in cross section (i.e. in a section at right angles to the longitudinal axis of the insert section), the insert section thus preferably has a circumference that bounds the cross section and corresponds to a round (preferably circular) shape apart from the site where the cutout is provided.

The lid may have been manufactured at least partly from plastic, where the plastic preferably comprises: PTFE, quartz and/or glass. As a result, the lid can firstly be easily produced and secondly can advantageously withstand the conditions that exist within the sample vessel space (especially the physical and/or chemical conditions, for example pressure, chemical substances, reactions).

When the insert section has been inserted into the sample vessel and the contact side lies on the edge, the flange is preferably flush with the edge. This means that, viewed in the direction of the longitudinal axis of the sample vessel, the flange preferably does not extend beyond the edge. The sample vessel system is thus particularly compact.

When the insert section has been inserted into the sample vessel and the contact side lies on the edge, the portion of the cutout that runs within the contact side may project beyond the edge. In other words, in this inserted state, the cutout may extend further radially outward than the edge. The cutout can thus be fluidically connected to the environment in a simple manner.

The sample vessel system may have a cover element (for example a cover plate or a lid) designed to prevent ingress of condensate, especially in the form of droplets, into the cutout. For example, the flange (viewed in a lateral view or in radial direction) may be provided between the cover element and the edge of the sample vessel. The cover element may be integral with or separate from the lid. In one embodiment, the cover element may have been placed onto the lid. In addition, the cover element may be designed to prevent ingress of condensate into the cutout of at least one further sample vessel system of the design as described above. The cover element is preferably configured such that the condensate flows (for example under gravity) to an edge of the cover element and then runs off at a defined distance from the sample vessel system (for example in the vicinity of a reactor or of a reactor wall). In particular, the cover element prevents the condensate from causing penetration of impurities into the sample vessel space, adversely affecting the sample accommodated therein. The cover element thus also improves an analysis conducted on the sample.

The sample vessel system may also comprise a stop element located so as to limit lifting of the lid inserted into the sample vessel. In other words, the stop element can have the effect that the lid can be raised only along a defined maximum pathway relative to the edge of the sample vessel. The stop element can especially prevent the lid from falling out of the sample vessel or becoming jammed. The stop element can also define a maximum gap between the contact side of the flange and the edge of the sample vessel, and hence a maximum opening of the cutout.

In a second aspect, the invention relates to a pressure vessel. The pressure vessel comprises a sample vessel system as described above. For example, the pressure vessel may comprise a reaction chamber as pressure space for triggering and/or promoting chemical and/or physical pressure reactions, where the sample vessel system is disposed in the reaction chamber. It is possible for one or more sample vessel systems to be disposed in the pressure vessel, preferably in the reaction chamber. The multiple sample vessel systems may be retained in a sample vessel receptacle (for example in the manner of a basket).

There follows a description of the invention by way of example with reference to the figures, which show preferred embodiments of the invention. The figures show:

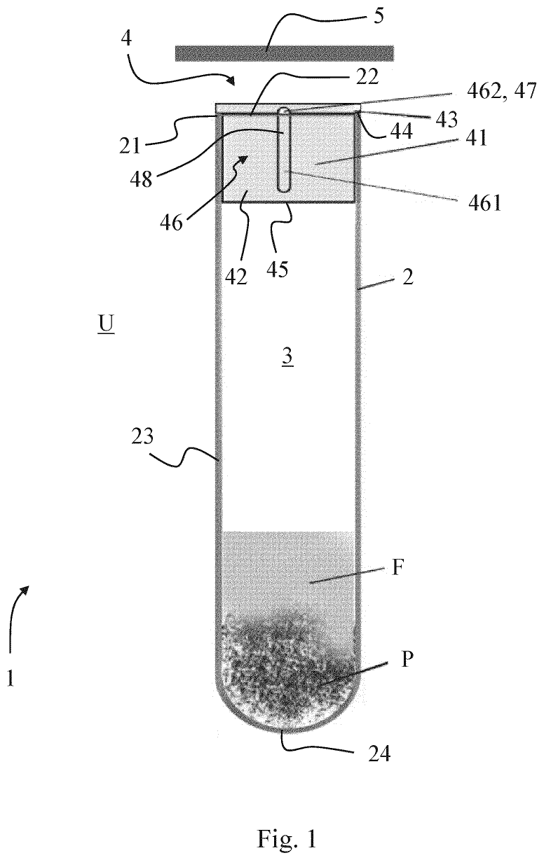

FIG. 1a schematic sectional view of a preferred embodiment of the sample vessel system of the invention, where the lid is in a first position;

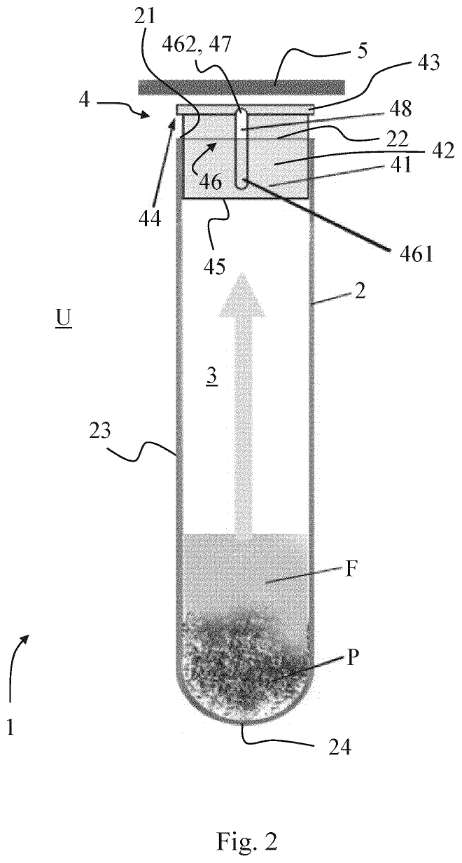

FIG. 2 a schematic sectional view of the embodiment shown in FIG. 1, where the lid is in a second position; and

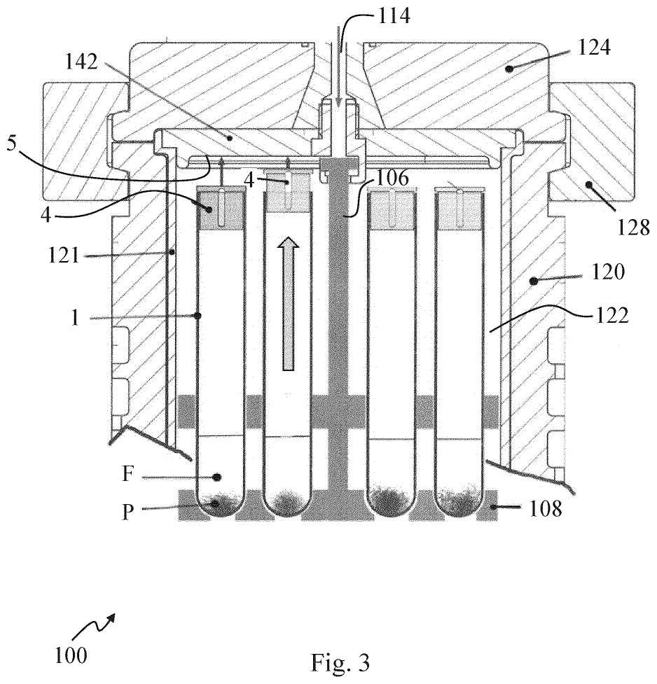

FIG. 3 a schematic sectional view of a preferred embodiment of the pressure vessel of the invention, in which multiple sample vessel systems, each as per the embodiment preferred in FIGS. 1 and 2, are provided.

FIGS. 1 and 2 show a sample vessel system 1 in a preferred embodiment. The sample vessel system 1 has a sample vessel 2 having a sample vessel space 3 to accommodate a sample P. It is optionally also possible to provide, in the sample vessel space 3, a liquid F (e.g. a solvent) in which the sample P is dissolved, for example. The sample vessel space 3 may comprise the sample P and/or the liquid F, where the rest of the volume of the sample vessel space 3 may be provided, for example, for a gas (e.g. a gas supplied to the sample vessel space 3 and/or a gas formed during a reaction that takes place in the sample vessel space 3).

The sample vessel 2 has an edge 21 that defines an opening 22. The edge 21 and the opening 22 may have a circular shape. The sample P and/or liquid F can be fed to the sample vessel space 3 via the opening 22. It is preferable when the sample vessel 2 has a lateral edge 23 that bounds the sample vessel space 3 and has the edge 21. The sample vessel 2 may have a base 24, from which the sidewall 23 extends. The sample vessel 2 is preferably elongated and thus preferably extends axially along a longitudinal axis. Viewed in cross section (i.e. along a section transverse to the longitudinal axis of the sample vessel 2), the sample vessel 2 can have a round/circular cross section. The sample vessel 2 is preferably a test tube.

The sample vessel system 1 also has a lid 4 set up to close the opening 22. The lid 4 has an insert section 41 having an outer surface 42. The lid can be inserted, especially plugged, via the insert section 41 into the sample vessel 2, namely via the opening 22. In this inserted state, at least a portion of the outer surface 42 is in contact with the sample vessel 2, especially with an inner face thereof. The insert section 41 preferably forms a press-fit with the sample vessel 2. This means that, in a state in which the insert section 41 has been inserted in the sample vessel 2, at least a portion of the outer surface 42 is pushed or pressed against a wall section of the sample vessel 2 owing to an elastic resilient force of the insert section 41. In other words, the outer surface 42 forms a press-fit surface of the insert section 41 that interacts with the sample vessel 2. The insert section 41, when inserted in the sample vessel 2, is held in a force-fitting manner, especially compressed, preferably between wall sections possessed, for example, by the sidewall 23.

The lid 4 is additionally movable axially relative to the sample vessel 2 via the insert section 41. In other words, the sample vessel 2 serves as a guide for axial movement (i.e. displacement) of the insert section 41 relative to the sample vessel 2. This suitability for axial movement means that the lid 4 can especially be moved away from the base 24 and toward the base 24 or, if present, away from the sample P and toward the sample P. The axial movement of the lid 4 is preferably along a movement axis that may be parallel to the longitudinal axis of the sample vessel 2. The insert section 41 is not restricted to a particular shape. It is preferable when the insert section 41, as shown by way of example in FIGS. 1 and 2, is at least partly cylindrical and hence has essentially a round/circular cross section. Alternatively or additionally, it may be the case that the insert section 41 has a conical shape.

The lid 4 also has a flange 43 which (considered in a top view, which corresponds, for example, to a view in the direction of the axis (e.g. axis of symmetry) of the insert section 41) extends radially outward proceeding from the insert section 41. It may thus be the case, for example, that the flange 43 has a greater diameter than the insert section 41. When the insert section 41 has been inserted in the sample vessel 2, the flange 43 is preferably flush with the edge 21. The flange 43 may have a diameter corresponding essentially to the diameter of the sample vessel 2. In other embodiments, the flange 43 may also extend beyond the edge 21. In addition, the diameter of the flange 43 may be greater than the diameter of the sample vessel 2. The diameter of the sample vessel 2 is defined as the diameter that defines an outer surface of the sample vessel 2 facing away from the sample vessel space 3 and/or a radially outer end of the edge 21.

The flange 43 has a contact side 44 via which the flange 43 and hence the lid 4 may lie on the edge 21. The contact side 44 preferably has a contact surface which is directed in the direction of the edge 21 and can make (two-dimensional) contact therewith when the lid 4 is inserted into the sample vessel 2. The flange 43 defines maximum entry of the insert section 41 into the sample vessel 2. In particular, the flange 43 prevents the lid 4 from entering too far into the sample vessel 2 and/or being in a position with its entirety below the edge 21, i.e. between edge 21 and base 24.

The lid 4 may have an underside 45 that preferably faces away from a top face of the lid 4 that has the flange 43, for example. In particular, the insert section 41 may have the underside 45. In a state in which the insert section 41 has been inserted into the sample vessel 2, the underside 45 is provided such that it bounds the sample vessel space 3 (at the top). It may thus be the case that the sample vessel space 3 is bounded at the top by the underside 45, laterally by the sidewall 23, and at the bottom by the base 24.

The lid 4 also has a cutout 46 which at first runs axially in the outer surface 42 of the insert section 41 and then runs radially outward in the contact side 44 of the flange 43. This means that the cutout 46 extends in the direction of the flange 43 and/or away from the underside 45 in the outer surface 42 of the insert section 41. The cutout 46 may extend away proceeding from the underside 45. The cutout 46 extends up to the flange 43, where it then merges into the contact side 44 and subsequently runs radially outward therein. The cutout 46 thus preferably runs at least along mutually adjoining sections 461, 462 that are preferably transverse (e.g. perpendicular) to one another. The first section 461 has the portion of the cutout 46 that runs within the outer surface 42, and the second section 462 the portion of the cutout 46 that runs within the contact side 44. It is preferable when a portion of the cutout 46 (i.e., for example, the section 461), in the state in which the lid 4 is inserted into the sample vessel 2, runs parallel to the longitudinal axis of the sample vessel 2. The portion of the cutout 46 that runs within the contact side 44 (i.e. section 462), preferably runs transverse, more preferably perpendicular, to the longitudinal axis of the sample vessel 2.

When the insert section 41 is inserted into the sample vessel 2 and the flange 43 lies on the edge 21 by its contact side 44, it is possible to fluidically connect the sample vessel space 3 to the environment U of the sample vessel system 1 via the cutout 46. The environment U has, for example, a reaction chamber and/or a gas present in the reaction chamber (which is not provided in the sample vessel space 3). The environment U may also include ambient air. There may in particular be a pressure in the environment U that differs from the pressure within the sample vessel space 3. The cutout 46 may have an opening 47 via which a gas can flow into the cutout 46 and hence into the sample vessel space 3. Alternatively or additionally, it may be the case that a gas will flow from the sample vessel space 3 into the cutout 46 and then is released via the opening 47 into the environment U. For example, the cutout 46 in the contact side 44 may extend as far as the radially outer end of the flange 43, where it then forms the opening 47. However, this is not obligatory since, for example, the portion of the cutout 46 that extends within the contact side 44 also extends beyond the edge 21, but in that case not as far as the outer radial end of the flange 43, in order to result in an inlet from the environment U into the cutout 46 and/or an outlet from the cutout 46 into the environment U.

The cutout 46 may at least partly take the form of a slot (or a channel or a groove or the like). At least the portion of the cutout 46 that runs within the outer surface 42 and/or within the contact side 44 may be provided in the form of a slot. The cutout 46 can be obtained by removing material at the outer surface 42 and/or the contact side 44. The cutout 46 may thus, for example, also be provided subsequently in a lid that does not have the cutout 46.

The sample vessel system 1 and/or the lid 4 may have further elements, especially elements that can interact with the fluid connection provided by the cutout 46. For example, the sample vessel system 1 (for example above the lid 4) may have a cover plate (not shown) which is designed to prevent ingress of condensate, especially in the form of droplets falling under gravity, into the cutout 46. For this purpose, the cover plate may be provided such that it extends further radially outward than the section of the cutout 46 that runs within the contact side 44. In a side view, the cover plate preferably extends such that at least the opening 47 is provided between that and the edge 21. An outer edge of the cover plate is preferably provided further radially outward than the outlet opening 47.

The lid 4 is not limited to a particular material. The lid 4 may be produced only from one material or from different materials. The lid 4 has preferably been manufactured at least partly from a plastic. The plastic may comprise: PTFE, quartz and/or glass. For example, it may be the case that at least or only the insert section 41 has been manufactured from a plastic, for example a plastic that imparts a defined elasticity, preferably greater than the elasticity of the flange 43, to the insert section 41. A defined elasticity of the insert section 41 is advantageous in particular in order to insert the lid 4 into the sample vessel 2, and especially to plug or compress it. In other embodiments, the lid 4 may also have been manufactured at least partly (or completely) from different materials, for example cork.

The sample vessel system 1 may also comprise a stop element 5 located so as to limit lifting of the lid 4 inserted into the sample vessel 2. The stop element 5 is preferably provided at a defined distance from the lid 4 when it lies on the edge 21 by its contact side 44. The distance is preferably measured between the stop element 5 and a top side of the lid 4 that includes the flange 43, for example. The stop element 5 can in particular prevent the lid 4 from falling out of the sample vessel 2 or the lid 4 from becoming jammed (for example with the sample vessel 2 and/or other parts, for example a pressure vessel). In other words, the lid 4, in a state in which it abuts the stop element 5, is still inserted in the sample vessel 2 by its insert section 41.

As can be seen from FIGS. 1 and 2, the lid 4 is movable axially between a first position and a second position by lifting relative to the sample vessel 2 (namely along the longitudinal axis of the sample vessel 2). FIG. 1 shows the first position by way of example. In the first position (in a lateral view of the sample holder 2 or the sidewall 23), at least a portion 48 of the cutout 46 (preferably including the first section 461) is covered by the sample vessel 2, especially by the sidewall 23. As a result, essentially the only way for a gas to leave the cutout 46 is via the opening 47. In other words, the cutout 46 and the portion of the sample vessel 2 that covers the cutout 26 bound a fluid conduit. It is then possible for a gas to enter the fluid conduit thus formed (in the direction of the sample vessel space 3) and/or to exit therefrom (in the direction of the environment U) via the opening 47. In the first position, the contact side 44 preferably lies on the edge 21, such that there is preferably no gap between these except for the cutout 46 running within the contact side 44 (along with the optional opening 47). The first position preferably constitutes an (unpressurized) state in which there is no pressure gradient between sample vessel space 3 and environment U.

FIG. 2 shows, by way of example, the second position of the lid 4. In this position, the portion 48 of the cutout 46 that was covered by the sample vessel 2 in the first position is moved out of the opening 22 in order to project beyond the edge 21. As a result, the portion 48 is exposed. The now exposed portion 48 thus increases the size of an outlet of the cutout 46, as a result of which an elevated gas flow can flow out of the cutout 46 into the environment U. In a preferred embodiment as shown by way of example in FIGS. 1 and 2, the outlet of the cutout 46 is then formed at least by the opening 47 and the exposed portion 48 of the cutout 46. In the second position, the contact side 44 is preferably spaced apart from the edge 21, which forms a gap between the contact side 44 and the edge 21, via which a fluid can flow out of the cutout 46 into the environment U. In the second position, a portion of the cutout 46 is preferably still covered by the sample vessel 2 or the sidewall 23.

The suitability of the lid 4 for movement from the first position shown in FIG. 1 to the second position shown in FIG. 2 is advantageous in particular for controlling a pressure (positive pressure) in the sample vessel space 3. If, for example, a reaction proceeding in the sample vessel space 3 results in evolution and/or expansion of a fluid (gas, liquid etc.) in the sample vessel space 3, the lid 4 is moved axially from the first position into the second position, the result of which is in particular that an unwanted or at least undesirably rapid rise in pressure in the sample vessel space 3 is prevented. There is thus no risk that a positive pressure in the sample vessel space 3 will cause the sample vessel 2 to burst or damage other parts of the sample vessel system 2, for example the lid 4. At the same time, the axial movement (i.e. the lifting) of the lid 4 into the second position increases the size of the outlet (for example in the form of a slot) of the fluid connection provided by the cutout 46 and hence automatically matches it to the evolution of fluid in the sample vessel space 3. In particular, the gases that evolve in the sample vessel space 3 during the reaction can thus escape rapidly from the sample vessel space 3 into the environment U.

FIG. 3 shows a preferred application of the sample vessel system 1, namely in a pressure vessel 100 which is, for example, a pressure reactor. The pressure vessel 100 thus includes the sample vessel system 1. The pressure vessel 100 is set up to accommodate one or more sample vessel systems 1 and for (direct and/or indirect) heating to trigger and/or promote chemical and/or physical pressure reactions on one or more samples P, for example by means of microwaves.

The pressure vessel 100 may be a (high-pressure) autoclave. The pressure vessel 100 preferably consists of a high-pressure-resistant material, for example metal, preferably steel, more preferably a corrosion-resistant stainless steel alloy. The pressure vessel 100 is preferably designed such that it is usable at pressures up to at least 200 bar, preferably up to at least 500 bar, and at temperatures of up to and even above 300° C.

The pressure vessel 100 may have a reaction chamber or precious space 122 for triggering and/or promoting the chemical and/or physical pressure reactions on the samples P. The reaction chamber 122 is preferably what is called a fluid space or gas space. The pressure vessel 100 may surround the reaction chamber 122 on all sides. The one or more sample vessel systems 1 are disposed in the reaction chamber 122 for sample treatment and are removable therefrom through an opening.

The pressure vessel 100 may have a (pot-shaped) lower portion 120 and a lid 124 (also called “lid portion”), which are mutually closable and, in the mutually closed state, surround the reaction chamber 122 on all sides. The lid 124 closes the opening provided in the pressure vessel 100, i.e. the lower portion 120 of the pressure vessel 100, for introduction and removal of the sample P. By means of the lid 124, the pressure vessel 100 and/or the reaction chamber 122 may consequently be opened and closed. The pressure vessel 100 may have a securing element 128, for example a clip that secures the lid 124 on the lower portion 120 in the mutually closed state, especially in such a way that they are not parted from one another during a pressure reaction that proceeds in the reaction chamber 122.

The reaction chamber 122 may be designed to accommodate a liquid or baseload. The liquid is preferably water, but may also be or include any other strongly microwave-absorbing liquid. The liquid is especially provided in order to heat or to warm the sample P present in the at least one sample vessel system 1. This can be effected, for example, in that the sample P is at least partly surrounded by the liquid and a microwave generator heats the liquid via microwave absorption.

The sample vessel 100 may also have a sample holder 108 with which one or more sample vessel systems 1 can be held in the reaction chamber 122. The sample holder 108 preferably takes the form of a basket to accommodate several sample vessel systems 1. The sample holder 108 is especially designed to introduce the at least one sample vessel system 1 into the reaction chamber 122, and remove it therefrom again by means of a rod-shaped handling structure (sample holder) 106, for example having a handle and/or flange region for securing, preferably by hanging, in the reaction chamber 122. The sample holder 108 may be hung on the lid 124 and/or the further lid 142 described hereinafter.

The sample vessel 100 may have a further lid (called a “liner”) 142 that has preferably been manufactured from plastic, for example PTFE. The further lid 142 preferably serves as part of a lining in order to at least partly cover a portion of the lid 124, for example the reverse side thereof. The further lid 142 bounds the reaction chamber 122, preferably in such a way that a fluid present in the reaction chamber 122 is in contact with the further lid 142 and hence preferably is not in contact with the lid 124. This prevents the lid 124 from being attacked in an unwanted manner by a fluid present in the reaction chamber 122.

Especially for protection of the inner wall of the lower portion 120, it is possible to provide a shell 121 therein, preferably manufactured from plastic, for example PTFE, which at least partly bounds the reaction chamber 122. The shell 121 thus preferably forms an inner lining, especially in the form of a vessel. The shell 121 is preferably provided such that it surrounds the reaction chamber 122 on all sides together with the further lid 142. It is preferable when at least a portion of the further lid 142 (for example a flange region) is provided and/or clamped between shell 121 and lid 124.

The pressure vessel 100 may have a fluid conduit 114 via which a charge gas can enter the reaction chamber 122 in order to increase a pressure therein (pressurization). The fluid conduit 114 preferably extends through the lid 124 and/or through the further lid 142.

It can be seen from FIG. 3 that the function of the sample vessel system 1 described in relation to FIGS. 1 and 2 can be employed for regulation of a pressure in the sample vessel space 3 in the pressure vessel 100. In particular, it is not required here that the pressure vessel 100 has means that regulate a pressure in the sample vessel space 3. Instead, the pressure that exists in the pressure vessel space 3 can simply be regulated exclusively via the configuration of the lid 4. This simplifies pressure regulation without adjusting the pressure vessel 100.

In particular, it is possible for a gas flowing out of the fluid conduit 114 to flow into the sample vessel space 3 via the fluidic connection provided at least by the cutout 46 of the sample vessel system 1. In addition, a gas (for example a reaction gas formed during a reaction that proceeds in the pressure vessel space 3) can escape into the reaction chamber 122 via the fluidic connection of the sample vessel system 1 and thence be removed from the pressure vessel 100, for example via an output conduit (not shown) possessed by the pressure vessel 100.

When the sample vessel system 1 is provided in the pressure vessel 100, the stop element 5 may be formed by a portion of the pressure vessel 100. For example, the lid 124 or the further lid 142 may include or form the stop element 5. For example, the stop element 5 may be integral with the lid 124 or the further lid 142. Alternatively or additionally, it may be the case that the sample holder 108 and/or handling structure 106 includes the stop element 5. For example, the stop element 5 may be provided releasably in or integrally with the handling structure 106.

The invention is not limited to the features described above; in particular, it is possible to combine the features described above with one another in any desired manner.

1. A sample vessel system (1) for use in a pressure vessel (100), comprising:
a sample vessel (2) having
a sample vessel space (3) to accommodate a sample (P) and
an edge (21) that defines an opening (22); and
a lid (4) to close the opening (22), where the lid (4) has:
an insert section (41) which is insertable into the sample vessel (2) via the opening (22) and via which the lid (4) is movable axially relative to the sample vessel (2),
a flange (43) which extends radially outward proceeding from the insert section (41) and, when the insert section (41) is inserted into the sample vessel (2), can lie on the edge (21) by a contact side (44), and
a cutout (46) that runs axially within an outer surface (42) of the insert section (41) and then radially outward in the contact side (44) of the flange, such that, when the insert section (41) is inserted into the sample vessel (2) and the flange (43) lies on the edge (21) by the contact side (44), the sample vessel space (3) is fluidically connected to the environment (U) of the sample vessel system (1) via the cutout (46).

2. The sample vessel system (1) as claimed in claim 1, wherein, when the insert section (41) is inserted into the sample vessel (2), the lid (4) is movable axially at least between a first position and a second position by lifting relative to the sample vessel (2), wherein at least a portion (48) of the cutout (46) is covered by the sample vessel (2) in the first position and projects beyond the edge (21) in the second position and hence is exposed.

3. The sample vessel system (1) as claimed in claim 1, wherein the sample vessel (2) extends axially along a longitudinal axis, and wherein, when the insert section (41) is inserted into the sample vessel (2), the portion of the cutout (46) that runs within the outer surface (42) runs at least partly parallel to the longitudinal axis.

4. The sample vessel system (1) as claimed in claim 1, wherein the cutout (46) is slot-shaped.

5. The sample vessel system (1) as claimed in claim 1, wherein the insert section (41) has an underside (45) which, when the insert section (41) is inserted into the sample vessel (2), bounds the sample vessel space (3), wherein the cutout (46) extends away from the underside (45) and/or proceeding from the underside (45).

6. The sample vessel system (1) as claimed in claim 1, wherein the insert section (41) is cylindrical and/or conical, and/or wherein the insert section (41) has a round, preferably circular, cross section.

7. The sample vessel system (1) as claimed in claim 1, wherein the lid (4) has been at least partly manufactured from plastic.

8. The sample vessel system (1) as claimed in claim 7, wherein the plastic comprises: PTFE, quartz and/or glass.

9. The sample vessel system (1) as claimed in claim 1, wherein, when the insert section (41) is inserted into the sample vessel (2) and the contact side (44) lies on the edge (21), the flange (43) is flush with the edge (21).

10. The sample vessel system (1) as claimed in claim 1, wherein, when the insert section (41) is inserted into the sample vessel (2) and the contact side (44) lies on the edge (21), the portion of the cutout (46) that runs within the contact side projects beyond the edge (21).

11. The sample vessel system (1) as claimed in claim 1, further comprising a cover element designed to prevent ingress of condensate, especially in the form of droplets, into the cutout (46), where the cover element is preferably a lid or a cover plate.

12. The sample vessel system (1) as claimed in claim 1, further comprising a stop element (5) located so as to limit lifting of the lid (4) inserted into the sample vessel (2), especially in order to prevent the lid (4) from falling out of the sample vessel (2).

13. A pressure vessel (100) having a sample vessel system (1) as claimed in any claim 1.
